(19) United States
(12) Patent Application Publication
(10) Pub. No.: US 2021/0071752 A1
(43) Pub. Date: Mar. 11, 2021

(54) REDUCTION GEARBOX FOR TURBINE FRACTURING

(71) Applicant: YANTAI JEREH PETROLEUM EQUIPMENT & TECHNOLOGIES CO., LTD., Yantai (CN)

(72) Inventors: Haiping Cui, Yantai (CN); Jixin Wang, Yantai (CN); Hailong Li, Yantai (CN); Wenping Cui, Yantai (CN); Xiaosong Wei, Yantai (CN); Peng Li, Yantai (CN)

(21) Appl. No.: 16/832,231

(22) Filed: Mar. 27, 2020

(30) Foreign Application Priority Data
Sep. 6, 2019 (CN) 201910844195.0

(51) Int. Cl. F16H 57/08; F16H 57/10; F02C 7/36; F16H 1/28

(52) U.S. Cl. CPC F16H 57/082; F16H 57/10; F16H 2057/02043; F16H 1/2836; F02C 7/36

(57) ABSTRACT

The present invention discloses a reduction gearbox for turbine fracturing with a compact overall structure, a small volume, a light weight and a large transmission ratio, wherein the power is input through a small end gear of the sun wheel axle, slowdown and increased the torque through the engagement between the big end gear of the sun wheel axle and the planetary gear, and output through the planetary carrier. A structure of the planetary gear set with reduced gear size and number is more suitable for the reduction requirement of a turbine engine. It can be observed through an observation hole by opening the cover plate, which is convenient for maintenance. A brake apparatus works with a brake pad so as to promptly stop the equipment in case of emergency to ensure the equipment and personal safety.

### TECHNICAL FIELD

The present invention relates to the technical field of turbine fracturing, and specifically to a reduction gearbox for turbine fracturing.

### BACKGROUND

For vehicle-mounted turbine fracturing equipment currently, a turbine engine is used as the power source, a reduction gearbox and a transmission shaft or a coupling are used as the transmission devices, and a fracturing plunger pump is used as the actuating element. The turbine engine itself has the advantages of small volume, light weight and high power density. For the same size and weight, the unit-power of a turbine fracturing equipment is more than twice that of conventional diesel fracturing equipment. The turbine engine can be fueled by 100% natural gas directly, unlike in electric drive fracturing equipment, there is no need for a middle stage of gas power generation, thus saving the investment cost on gas generator sets. Meanwhile, a turbine fracturing equipment is employed to distribute the failure risk of a single high-power gas generator onto each turbine fracturing equipment, avoiding that the failure of a single gas generating equipment causes the risk of breakdown of the whole set of fracturing equipment.

The planetary gear reduction gearbox installed in the turbine fracturing equipment often adopts a cantilever overall structure due to its small space. However, if the support of the planetary carrier is not properly handled, the stiffness of the planetary carrier may decrease, the vibration will increase, and the unevenness of gear meshing parts will be strengthened, thus greatly reducing the reliability and life of planetary gear transmission.

Therefore, there is an urgent need for a reduction gearbox for turbine fracturing with convenient installation, compact overall structue and good transmission performance.

### SUMMARY

To overcome the deficiencies in the prior art, an objective of the present invention is to provide a reduction gearbox for turbine fracturing with a compact overall structure, a small volume, a light weight and a large transmission ratio, wherein the power is input through a small end gear of the sun wheel axle, slowdown and increased the torque through the engagement between the big end gear of the sun wheel axle and the planetary gear, and output through the planetary carrier. A structure of the planetary gear set with reduced gear size and number is more suitable for the reduction requirement of a turbine engine. It can be observed through an observation hole by opening the cover plate, which is convenient for maintenance. A brake apparatus works with a brake pad so as to promptly stop the equipment in case of emergency to ensure the equipment and personal safety.

The objective of the present invention is achieved by the following technical measures: a reduction gearbox for turbine fracturing, including a sun wheel axle, a planetary gear and a bearing, there are three planetary gears and six bearings, the planetary gears are muff-coupled with the bearings one-to-two to form three groups of planetary gear sets; the sun wheel axle includes a big end gear and a small end gear, the three groups of planetary gear sets are distributed with the big end gear as the center of a circle, and the planetary gear engages with the big end gear.

Further, the three groups of planetary gear sets are evenly distributed with the big end gear as the center of a circle.

Further, the big end gear includes a first big end gear and a second big end gear, the first big end gear is a right-hand helical gear, and the second big end gear is a left-hand helical gear.

Further, the planetary gear includes a first gear tooth surface and a second gear tooth surface, the first gear tooth surface is a left-hand helical tooth surface, and the second gear tooth surface is a right-hand helical tooth surface.

Further, the first big end gear engages with the first gear tooth surface, and the second big end gear engages with the second gear tooth surface.

Further, the reduction gearbox includes an input bearing, a flange, an inner gear ring and a planetary carrier, the flange is connected to the inner gear ring, the flange is provided with an input bearing, the input bearing is sleeved on the sun wheel axle, the inner gear ring engages with the planetary gear of the planetary gear sets, and the planetary carrier is connected to the bearing through an axis pin.

Further, the reduction gearbox includes an output splined shaft and an output splined sleeve, one end of the output splined shaft is connected to the output splined sleeve, and the other end of the output splined shaft is connected to the planetary carrier.

Further, the reduction gearbox includes an upper box, a lower box and an output axis pin, the upper box and the lower box are connected to form a protective box outside the reduction gearbox, one side of the protective box is connected to the flange, and the other side of the protective box is connected to the output splined shaft through an output axis pin.

Further, the upper box is provided with an observation hole, which is covered with a cover plate.

Further, the upper box is provided with a brake apparatus, the output splined sleeve is provided with a brake pad, and the brake apparatus works with the brake pad.

Compared with the prior art, the present invention has the following beneficial effects: the reduction gearbox of the present invention has a compact overall structure, a small volume, a light weight and a large transmission ratio, wherein the power is input through a small end gear of the sun wheel axle, slowdown and increased the torque through the engagement between the big end gear of the sun wheel axle and the planetary gear, and output through the planetary carrier. A structure of the planetary gear set with reduced gear size and number is more suitable for the reduction requirement of a turbine engine. It can be observed through an observation hole by opening the cover plate, which is convenient for maintenance. A brake apparatus works with a brake pad so as to promptly stop the equipment in case of emergency to ensure the equipment and personal safety. A double row herringbone gear meshing structure is used between the planetary gear and the sun gear, increasing the contact area, decreasing the vertical pressure on the gears, facilitating the flow of lubricating oil, eliminating the transverse force on the helical gear shaft, thus allowing a high contact ratio of gears, a small axial load, a high bearing capacity, and more smoothly running.

The present invention will be described in detail below with reference to the accompanying drawings and specific implementations.

### BRIEF DESCRIPTION OF THE DRAWINGS

FIG. 1 is a schematic diagram of the internal structure of a reduction gearbox for turbine fracturing of the invention.

FIG. 2 is a schematic structural diagram of the reduction gearbox for turbine fracturing.

FIG. 3 is a schematic structural diagram of a planetary reduction of the reduction gearbox for turbine fracturing.

FIG. 4 is a schematic structural diagram of a planetary gear of the reduction gearbox for turbine fracturing.

FIG. 5 is a schematic structural diagram of a sun wheel axle of the reduction gearbox for turbine fracturing.

FIG. 6 is a schematic structural diagram of an output splined sleeve of the reduction gearbox for turbine fracturing.

Wherein, 1. lower box, 2. sun wheel axle, 3. flange, 4. upper box, 5. cover plate, 6. brake apparatus, 7. output splined sleeve, 8. output splined shaft, 9. planetary carrier, 10. inner gear ring, 11. planetary gear, 12. axis pin, 13. bearing, 14. input bearing, 15. output bearing, 16. the first big end gear, 17. the second big end gear, 18. the first gear tooth surface, 19. the second gear tooth surface, 20. brake pad, 21. small end gear.

### DESCRIPTION OF THE EMBODIMENTS

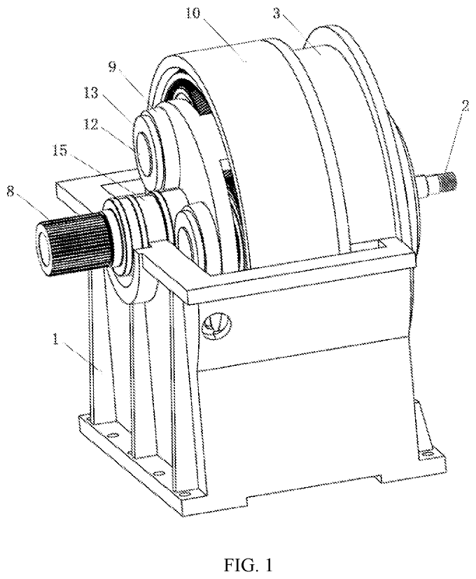

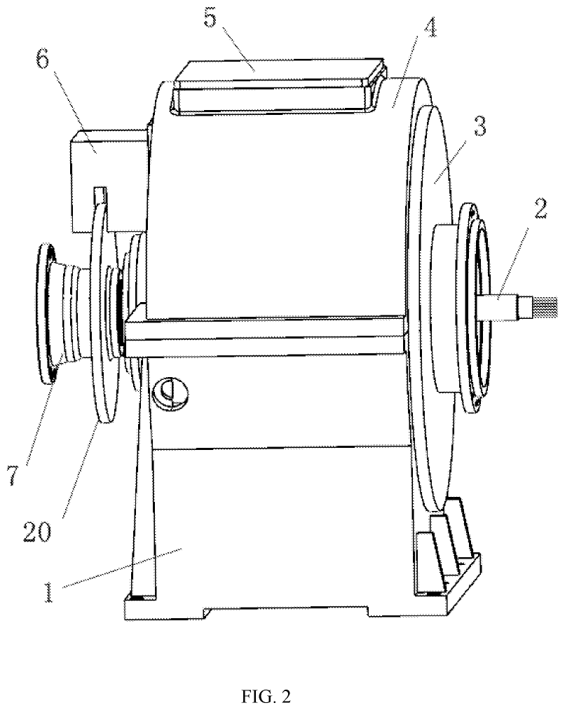

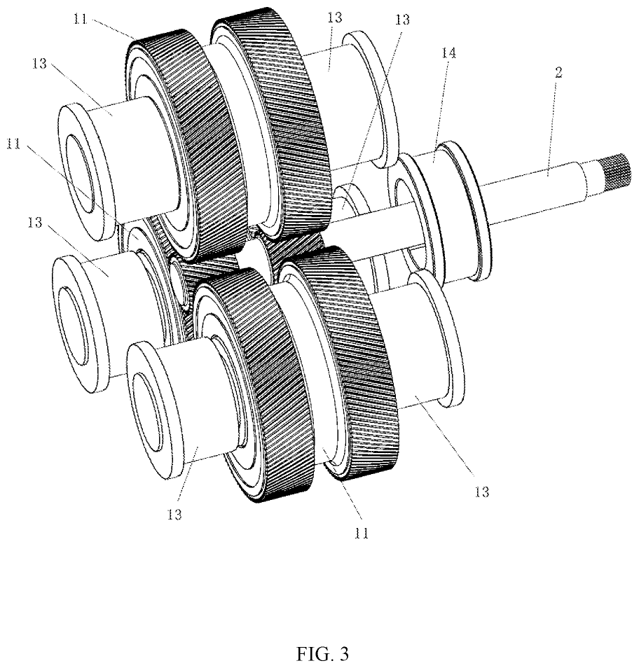

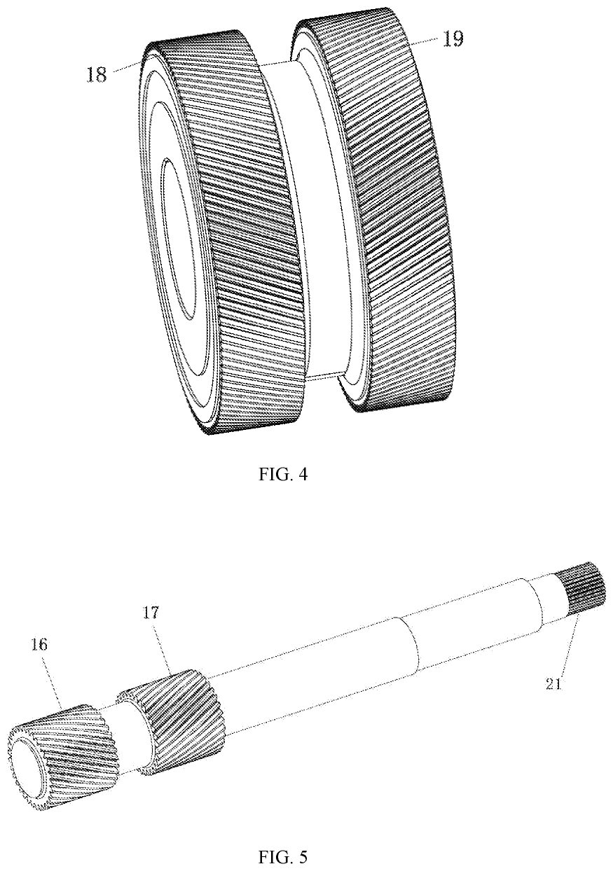

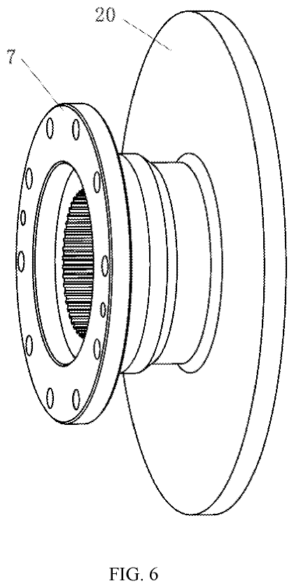

As shown in FIGS. 1 to 6, a reduction gearbox for turbine fracturing, including a sun wheel axle 2, a planetary gear 11 and a bearing 13, there are three planetary gears 11 and six bearings 13, the bearings 13 in pairs are used to fix one planetary gear 11, and the six bearings 13 and the three planetary gears 11 are respectively muff-coupled to form three groups of planetary gear sets; the sun wheel axle 2 includes a big end gear and a small end gear, the three groups of planetary gear sets are distributed with the big end gear as the center of a circle, and the planetary gear 11 engages with the big end gear. The three groups of planetary gear sets are evenly distributed with the big end gear as the center of a circle. The reduction gearbox has a large transmission ratio. The power is input through a small end gear of the sun wheel axle, slowdown and increased the torque through the engagement between the big end gear of the sun wheel axle and the planetary gear 11, and output through the planetary carrier 9. A structure of the planetary gear set with reduced gear size and number is more suitable for the reduction requirement of a turbine engine. The big end gear includes a first big end gear 16 and a second big end gear 17, the first big end gear 16 is a right-hand helical gear, the second big end gear 17 is a left-hand helical gear. The planetary gear 11 includes a first gear tooth surface 18 and a second gear tooth surface 19, the first gear tooth surface 18 is a left-hand helical tooth surface, and the second gear tooth surface 19 is a right-hand helical tooth surface. The first big end gear 16 engages with the first gear tooth surface 18, and the second big end gear 17 engages with the second gear tooth surface 19, so that a double row herringbone gear meshing structure is used between the planetary gear 11 and the sun gear, increasing the contact area, decreasing the vertical pressure on the gears, facilitating the flow of lubricating oil, eliminating the transverse force on the helical gear shaft, thus allowing a high contact ratio of gears, a small axial load, a high bearing capacity, and more smoothly running. The reduction gearbox includes an input bearing 14, a flange 3, an inner gear ring 10 and a planetary carrier 9, wherein the flange 3 is connected to the inner gear ring 10, the flange 3 is provided with an input bearing 14, the input bearing 14 is sleeved on sun wheel axle 2, the inner gear ring 10 engages with the planetary gear 11 of the planetary gear set, and the planetary carrier 9 is connected to the bearing 13 through an axis pin 12. The reduction gearbox includes an output splined shaft 8 and an output splined sleeve 7, one end of the output splined shaft 8 is connected to the output splined sleeve 7, and the other end of the output splined shaft 8 is connected to the planetary carrier 9. The reduction gearbox includes an upper box 4, a lower box 1 and an output bearing 15, the upper box 4 and the lower box 1 are connected to form a protective box outside the reduction gearbox, one side of the protective box is connected to the flange 3, and the other side of the protective box is connected to the output splined shaft 8 through an output bearing 15. The reduction gearbox has a compact overall structure, a small volume and a light weight.

The upper box 4 is provided with an observation hole, which is covered with a cover plate 5. The internal operation situation of the protective box can be viewed through the observation hole after opening the cover plate 5, such as the engagement of gears, the wear of tooth surfaces, and the like, which is convenient for maintenance without the need of opening the protective box.

The upper box 4 is provided with a brake apparatus 6, the output splined sleeve 7 is provided with a brake pad 20, the brake apparatus 6 works with the brake pad 20 so as to promptly stop the equipment in case of emergency to ensure the equipment and personal safety.

In the course of actual use, the small end gear of the sun wheel axle 2 is connected to the turbine engine, the output splined sleeve 7 is connected to the transmission shaft, the rotation speed of the turbine engine is transferred to the transmission shaft through the reduction gearbox for turbine fracturing, so as to reduce the rotation speed and increase the output torque.

It will be appreciated to persons skilled in the art that the present invention is not limited to the foregoing embodiments, which together with the context described in the specification are only used to illustrate the principle of the present invention. Various changes and improvements may be made to the present invention without departing from the spirit and scope of the present invention. All these changes and improvements shall fall within the protection scope of the present invention. The protection scope of the present invention is defined by the appended claims and equivalents thereof.

1. A reduction gearbox for turbine fracturing, wherein the reduction gearbox comprises a sun wheel axle, [a] three planetary gears and [a] six first bearings, two ends of each planetary gear are connected to a first bearing respectively; the sun wheel axle comprises a big end gear and a small end gear, the three planetary gears are centered around the big end gear, and engage with the big end gear.

2. The reduction gearbox for turbine fracturing according to claim 1, wherein the three planetary gears are evenly centered around the big end gear.

3. The reduction gearbox for turbine fracturing according to claim 1, wherein the big end gear comprises a first gear and a second gear, the first gear is a right-hand helical gear, and the second gear is a left-hand helical gear.

4. The reduction gearbox for turbine fracturing according to claim 3, wherein the planetary gear comprises a first gear tooth surface and a second gear tooth surface, the first gear tooth surface is a left-hand helical tooth surface, and the second gear tooth surface is a right-hand helical tooth surface.

5. The reduction gearbox for turbine fracturing according to claim 4, wherein the first big end gear engages with the first gear tooth surface, and the second big end gear engages with the second gear tooth surface.

6. The reduction gearbox for turbine fracturing according to claim 1, wherein the reduction gearbox comprises a second bearing, a flange, an inner gear ring and a planetary carrier, the flange is connected to the inner gear ring, the second bearing is disposed in the flange and sleeved on the sun wheel axle, the inner gear ring engages with the planetary gears, and the planetary carrier is connected to the first bearings through [an] axis pins.

7. The reduction gearbox for turbine fracturing according to claim 6, wherein the reduction gearbox comprises an output splined shaft and an output splined sleeve, one end of the output splined shaft is connected to the output splined sleeve, and the other end of the output splined shaft is connected to the planetary carrier.

8. The reduction gearbox for turbine fracturing according to claim 7, wherein the reduction gearbox comprises an upper box, a lower box and a third bearing, the upper box and the lower box are connected to form a protective box outside the reduction gearbox, [one] a first side of the protective box is connected to the flange, and a second side of the protective box is connected to the output splined shaft through the third bearing.

9. The reduction gearbox for turbine fracturing according to claim 8, wherein the upper box is provided with an observation hole, which is covered with a cover plate.

10. The reduction gearbox for turbine fracturing according to claim 8, wherein the upper box is provided with a brake apparatus, the output splined sleeve is provided with a brake pad, and the brake apparatus works with the brake pad.
